(19) United States
(12) Patent Application Publication
(10) Pub. No.: US 2025/0308224 A1
(43) Pub. Date: Oct. 2, 2025

(54) SYSTEMS AND METHODS FOR SELF-SUPERVISED FACIAL LANDMARK DETECTION

(71) Applicant: L'Oreal, Paris (FR)

(72) Inventors: Varshanth Ravindra Rao, Scarborough (CA); Kejia Yin, Toronto (CA)

(73) Assignee: L'Oreal, Paris (FR)

(21) Appl. No.: 18/622,720

(22) Filed: Mar. 29, 2024

(51) Int. Cl. G06V 10/82; G06V 10/80; G06V 40/16

(52) U.S. Cl. CPC G06V 10/82; G06V 10/80; G06V 40/165

(57) ABSTRACT

There is provided systems and methods for self-supervised learning (SSL) in face detection networks. In an embodiment a face detection network comprises encoder components configured for encoding features of the face, the encoder components comprising trained components of a Masked Image Modeling (MIM) network configured to processes non-overlapping patches determined from the input image, the MIM network trained with a SSL objective; and decoder components configured through training for determining local correspondences between the features for determining estimates for the facial landmarks. In an embodiment, the MIM network is an MAE network. In an embodiment the decoder components are derived from those of a trained second network comprising the encoder components as trained but frozen, wherein the decoder components of the second network are trained using a locality constrained repellence (LCR) loss. Methods are provided for SSL training of the encoder and decoder components.

### FIELD

This disclosure relates to computer vision and image processing using deep neural networks and more particularly to systems and methods for self-supervised facial landmark detection.

### BACKGROUND

Self-supervised landmark estimation is a challenging task that demands the formation of locally distinct feature representations to identify sparse facial landmarks in the absence of annotated data. To tackle this task, existing state-of-the-art (SOTA) methods (1) extract coarse features from backbones that are trained with instance-level self-supervised learning (SSL) paradigms, which neglect the dense prediction nature of the task, (2) aggregate them into memory-intensive hypercolumn formations, and (3) supervise lightweight projector networks to naively establish full local correspondences among all pairs of spatial features.

### SUMMARY

There is provided, (e.g. in embodiments), systems and methods for self-supervised facial landmark detection that leverages a region-level SSL method, operates on a vanilla feature map instead of on expensive hypercolumns, and employs a Correspondence Approximation and Refinement Block (CARB) that utilizes a simple density peak clustering algorithm and the proposed Locality-Constrained Repellence Loss to directly hone only select local correspondences. There is demonstrated through extensive experiments that such a framework is highly effective and robust, outperforming existing SOTA methods by large margins of ˜20%-44% on the landmark matching and ˜9%-15% on the landmark detection tasks. As multiple new features are provided, it will be apparent that not all embodiments may incorporate each of the new features (e.g. an embodiment may only incorporate one of the new features).

There is provided systems and methods for self-supervised learning (SSL) in face detection networks. In an embodiment a face detection network comprises encoder components configured for encoding features of the face, the encoder components comprising trained components of a Masked Image Modeling (MIM) network configured to processes non-overlapping patches determined from the input image, the MIM network trained with a SSL objective; and decoder components configured through training for determining local correspondences between the features for determining estimates for the facial landmarks. In an embodiment, the MIM network is an MAE network. In an embodiment the decoder components are derived from those of a trained second network comprising the encoder components as trained but frozen, wherein the decoder components of the second network are trained using a locality constrained repellence (LCR) loss. Methods are provided for SSL training of the encoder and decoder components.

### BRIEF DESCRIPTION

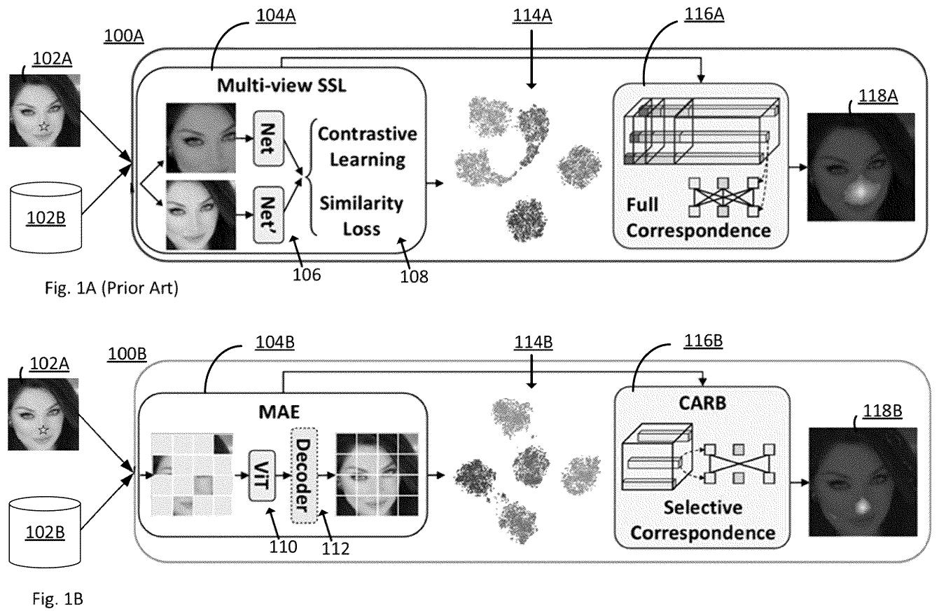

FIG. 1A shows a self-supervised facial landmark detection framework (e.g. as a plurality of stages with representative input and output) in accordance with the prior art.

FIG. 1B shows a self-supervised facial landmark detection framework (e.g. as a plurality of stages (e.g. components of a system (e.g. as software structures)) with representative input and output) in accordance with the an embodiment herein.

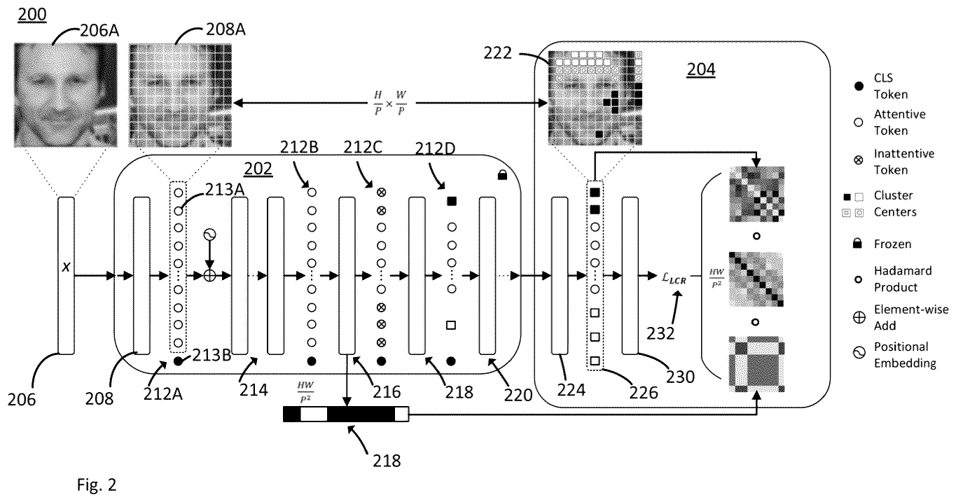

FIG. 2 shows an embodiment of a self-supervised facial landmark detection framework similar to FIG. 1B.

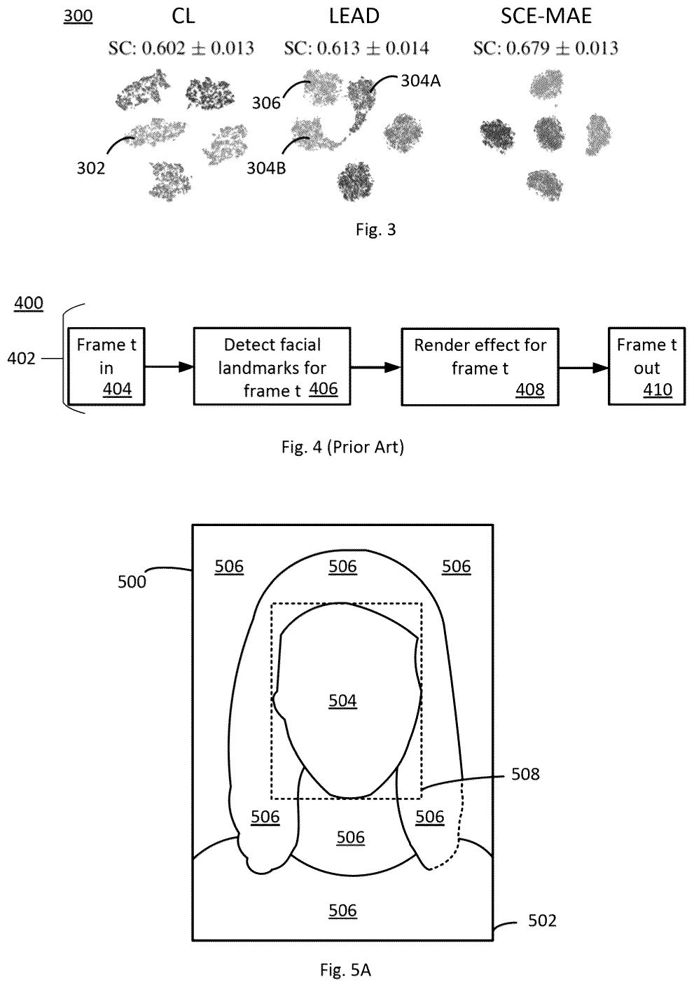

FIG. 3 shows t-SNE plots of the landmark representations for each of two prior art frameworks and an embodiment of a framework disclosed herein.

FIG. 4 is a block diagram of operations of a single threaded effects pipeline in accordance with a prior art embodiment.

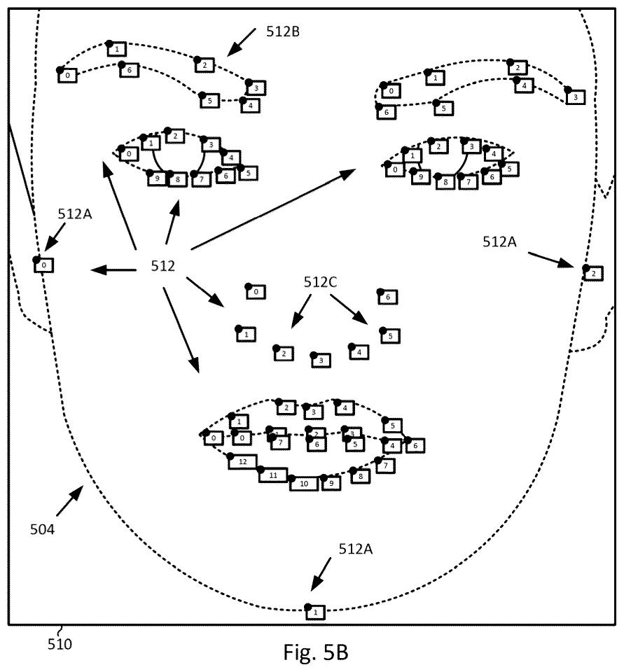

FIG. 5A is an illustration showing a representative frame t (an example of a face image) including a face and background.

FIG. 5B is an illustration of output of a face tracker of an effects pipeline showing a cropped face image and groups of face points in accordance with an embodiment.

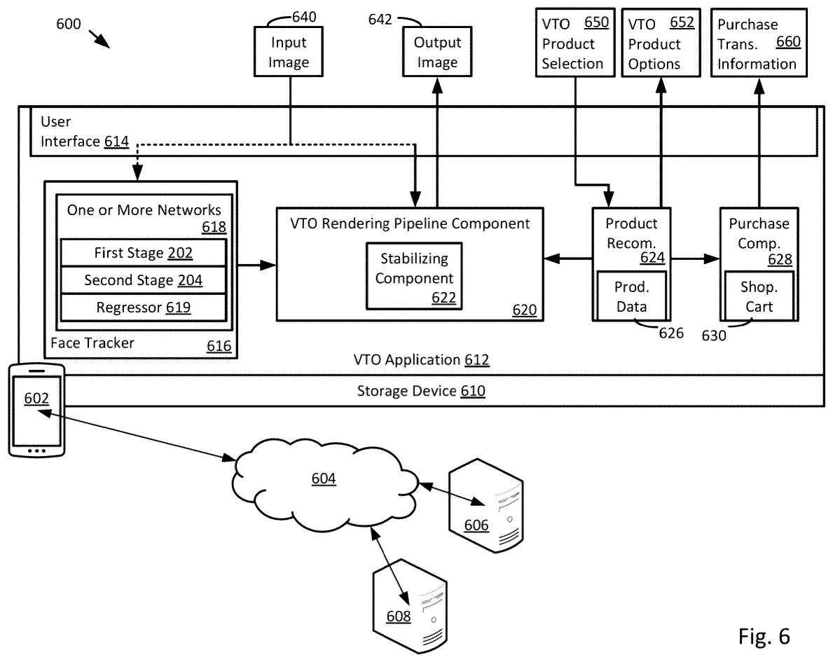

FIG. 6 is an illustration of a computing environment, in accordance with an embodiment, such as for performing a virtual try on.

### DETAILED DESCRIPTION

Facial landmark detection is a computer vision task involving the identification and localization of specific keypoints corresponding to particular positions on a human face. Facial landmarks form the crux for many classical downstream tasks such as 3D face reconstruction, face recognition, face emotion/expression recognition, and more contemporary applications such as facial beauty prediction and face make-up try on or virtual try on (“VTO”).

Albeit extremely useful, training facial landmark detectors requires numerous precise annotations per sample, making it a laborious and expensive ordeal. Furthermore, landmarks are not always semantically well-defined, making their annotations prone to inconsistencies and, which can severely limit the development of accurate landmark models. Motivated to avoid these demerits, recent works have incorporated the unsupervised and self-supervised learning (SSL) paradigms into their methods. SSL-pretrained models have shown to yield highly effective feature representations without the use of labeled data and, at many times, outperform their supervised counterparts on the target tasks.

Facial landmark detection and matching tasks rely on the formation of locally distinct features to differentiate between (1) the facial regions (e.g., eye vs. lip), (2) the components of face parts (e.g., left vs. right corners of the lip), and finally, (3) the specific pixels of each landmark. In the setting where annotations are severely limited, some recent methods follow a two-stage training protocol. During the first stage, the backbone is trained with a typical SSL objective. In the second stage, the backbone is frozen and a separate light-weight projector network is trained to encode local correspondences, i.e., the relationships between the different regions within the same image.

Prior work adopted multi-view SSL protocols, which may be less effective on the landmark estimation tasks due to several factors. Firstly, these augment-and-compare pretext tasks prompt the network to learn category-specific signals, but the framework task herein operates only on a single category, i.e., the human face. Secondly, contrastive learning requires a large and diverse set of negative samples to avoid collapse. Lastly, the training objectives might not directly encourage the model to learn the intricate facial cues within the positive face samples to differentiate between facial regions, which are required for dense tasks such as landmark detection and matching.

On the other hand, the Masked Image Modeling (MIM) protocol requires the network to reconstruct the masked regions from limited context. For example, for an input image, 75% of the image is masked, leaving patches comprising 25% with which to reconstruct the input image.

In accordance with a teaching herein, based on an observation that the non-landmark regions (e.g., cheeks and foreheads) are larger and more uniform than the sparse and distinctive landmark regions (e.g., the eyes and lip corners), it is hypothesized, without restricting Applicant to being held to such hypothesis, that the reconstruction of the masked landmark regions leads to the formation of effective representations of the facial landmarks. In an embodiment, the Masked Autoencoder (MAE) as described in He, Kaiming, Xinlei Chen, Saining Xie, Yanghao Li, Piotr Dollar and Ross B. Girshick, “Masked Autoencoders are Scalable Vision Learners.” 2022 IEEE/CVF Conference on Computer Vision and Pattern Recognition (CVPR) (2021): 15979-15988 (which is incorporated by reference herein in its entirety), is adopted as the backbone network in the first stage of the framework. It will be appreciated that another network following a MIM protocol can be employed as the first stage backbone network.

In a MAE-based network such as described in He et al., an encoder maps the observed signal to a latent representation, and a decoder reconstructs the original signal from the latent representation. An asymmetric design can be employed. The asymmetric design allows the encoder to operate only on the partial, observed signal (e.g. without mask tokens), and a lightweight decoder is used for full signal reconstruction from the latent representation and mask tokens. Following the vision transformer approach (e.g. a vision transformer (ViT) using self-attention mechanisms to process images), an input image is divided into non-overlapping patches. MAE samples from the patches to determine which patches to mask (or not mask as the case may be). The MAE encoder of He et al. embeds patches by a linear projection with added positional embeddings. The result is processed by a series of Transformer blocks. Only the unmasked patches are processed by the encoder, with the masked patches removed. No mask tokens are used in the encoder. A full set of tokens (i.e. the encoded visible patches supplemented with mask tokens) are inputs to the decoder. A shared, learned vector that indicates the presence of a missing patch to be predicted defines each mask token. Positional embeddings are added to all tokens in this full set, giving location information to mask tokens, for example. The decoder comprises its respective set of Transformer blocks. The MAE decoder of He et al. may only used during an initial training (e.g. a pre-training) to perform the image reconstruction task to obtain a trained encoder for tasks. For example, only the encoder is used to produce image representations for recognition. Architecture of the decoder can be independently designed. Small decoders, (e.g. in terms of Transformer blocks) that are narrower and shallower than the encoder can be utilized, providing asymmetry. As a result, and in accordance with He et al. a reduced set of inputs are processed by the encoder and the full set of tokens is processed by a lightweight decoder reducing training time.

For the second stage, both CL (Cheng, Zezhou, Jong-Chyi Su, and Subhransu Maji. “On equivariant and invariant learning of object landmark representations.” In Proceedings of the IEEE/CVF International Conference on Computer Vision, pp. 9897-9906. 2021, incorporated herein by reference in its entirety) and LEAD (Karmali, Tejan, Abhinav Atrishi, Sai Sree Harsha, Susmit Agrawal, Varun Jampani, and R. Venkatesh Babu. “Lead: Self-supervised landmark estimation by aligning distributions of feature similarity.” In Proceedings of the IEEE/CVF Winter Conference on Applications of Computer Vision, pp. 623-632. 2022, incorporated herein by reference in its entirety) utilize objectives to establish correspondences between each pair of feature descriptors within the same image. Based on the earlier observation that non-landmark regions are larger and more uniform, it was posited: is it necessary to establish correspondences between all feature descriptor pairs? It is further hypothesized, without restriction to being held to such hypothesis, that the selective refinement of the important correspondences utilizes the network's parameters more effectively. To this end, in an embodiment, a novel Correspondence Approximation and Refinement Block (“CARB”) is employed in the second stage. First the MAE's output (first stage MIM output) is differentiated into attentive (landmark and important facial regions) and inattentive (insignificant facial regions or background) tokens using first-stage correspondence signals. Next, in an embodiment a clustering algorithm operates on the inattentive tokens and approximates the member tokens using the cluster center. Finally, in an embodiment a light-weight projector network is supervised using a novel Locality-Constrained Repellence (“LCR”) Loss that penalizes the erroneous strong correspondences between the different token types weighted by spatial proximity. Here, only the select correspondences are directly refined since the loss operates only on the attentive tokens and inattentive cluster center proxies.

FIG. 1A shows, at a high level, a SSL framework 100A in accordance with the prior art. The framework shows components of a system comprising a computing device (or more than one such device) configured such as through software. The software comprises instructions stored in a non-transient storage device (e.g. a memory of the computing device) that when executed (e.g. by at least one processor of the system) cause the system (e.g. its computing device) to perform operations of a method. FIG. 1B shows, at a high level, a SSL framework 100B, in accordance with an embodiment of a proposed Selective Correspondence Enhancement (SCE) with MAE (SCE-MAE) framework. In each case there is provided as input an example query 102A and an unannotated dataset 102B of facial images (e.g. in different poses).

It will be appreciated that each framework shown or described herein can be implemented using respective components in a system comprising a computing device (or more than one such device) configured using respective software. The software comprises instructions stored in a non-transient storage device (e.g. a memory of the computing device) that when executed by at least one processor of the computing device cause the computing device (e.g. the system) to perform operations of a respective method.

Stage 1 104A of framework 100A in accordance with the prior art uses instance-level multi-view SSL paradigms that output less distinct initial local features. For Stage 1 102A, a query image is transformed (e.g. randomly) and processed via respective networks (e.g. 106) using contrastive learning and similarity loss(es) 108.

Stage 1 104B of the SCE-MAE framework 100B leverages MAE to naturally form better initial features that result in well-defined boundaries between facial landmarks. The query image 102A is randomly masked in patches and processed with a ViT-based transformer block (e.g. an encoder 110) and a transformer block decoder 112 that is discarded after a first stage training, the decorder trained to regenerate the query image as output.

Representative t-SNE plots (114A and 114B) illustrate the differences in boundaries (these are representational only and not necessarily true data plots for a left eye, a right eye, a nose, left lip corner and a right lip corner. The plots 114A and 114B are shown in greyscale for easy of patent reproduction reasons but could be in color to better distinguish one landmark type from another).

Stage 2 116A in accordance with the prior art operates on memory-intensive hypercolumns and supervises each feature pair to achieve a full correspondence. Stage 2 116B of the embodiment of the SCE-MAE framework 100B employs a Correspondence Approximation and Refinement Block (CARB) that operates on the original MAE output and directly hones only the selected correspondence pairs. For the example query, SCE-MAE outputs a more-focused and sharper similarity map, demonstrating the superiority of the final features. Representational output 118A and 118B show differences for the facial landmark query results (e.g. a nose region) for each of the frameworks 100A and 100B.

Related work for Self-Supervised Learning (SSL). By solving unique pretext tasks, SSL methods are able to learn discriminative feature representations from unlabeled data. Early works explored pretext tasks such as predicting the rotation angle and recovering the original image from random permuted patches. Recently, invariant and contrastive learning based SSL methods have gained popularity due to their ability to capture high-level semantic concepts from the data. Invariant learning aims to learn transformation invariant features by forcing the representations of two randomly augmented views of the same image to be similar. Contrastive learning defines different views of an anchor image as positives and views of different images as negatives. Here, the objective is to pull the representations of the anchor and positives together while pushing apart those of the anchor and negatives. These methods operate at the encoded image or instance-level and can be categorized as augment-and-compare SSL methods.

The Masked Image Modeling (MIM) protocol has gained significant momentum. These methods operate at the region-level and learn to recover the masked regions from the contextual information contained in the unmasked patches. It has been empirically shown that by using non-extreme masking ratios or patch sizes in Masked Autoencoders (MAE), the representation abstractions capture robust high-level information, while extreme masking ratios capture more low-level information. With higher masking ratios as the norm, MAE executes dense reconstruction, making them intrinsically suitable for dense prediction tasks.

For the first stage of self-supervised face landmark detectors, others have utilized pretrained backbones that do not operate explicitly at the sub-image (region/pixel) level. On the other hand, the sparse nature of facial landmarks perfectly matches the MIM objective to reconstruct the whole view from unmasked patches, can result in higher fidelity coarse local features.

Related work for Unsupervised Landmark Prediction. To tackle landmark prediction without annotated data, there have been several approaches. Equivalence learning leverages transformation equivalence as a free supervision signal to learn landmark embeddings. Since an undesirable constant vector output would satisfy the objective, adding a diversity loss or enabling similarity enforcement through intermediate auxiliary images are proposed to tackle the issue. Another approach is through generative modeling where landmarks are discovered by training networks with a reconstruction objective such as reconstructing the human image with a different pose.

Other works such as ContrastLandmark (CL) [9] and LEAD [19] have adopted SSL methods to extract coarse features that capture the broad semantic concept and further process them to establish regional/local correspondences. These other works construct hypercolumns and compact them using proximity-guided and correspondence guided reduction objectives respectively. While both methods reduce the final representation size, hypercolumns are memory-wise enormous structures and operating on them is a computationally intensive process. Furthermore, each spatial feature pair is subject to the optimization objective, neglecting the possibility that some local correspondences do not contribute as much to the downstream task.

On the contrary, using an embodiment of the SCE-MAE framework, there is no need to operate on expensive hypercolumns, and the SCE-MAE framework identifies and directly process only salient local correspondences.

Reference is directed to an embodiment of the SCE-MAE framework 200 illustrated in FIG. 2. In brief, the embodiment depicts a Masked Image Modeling type first stage 202, which is implemented as the MAE followed by a second stage 204 in which processing proceeds by way of selective correspondence through the process of reducing the effective number of final correspondence pairs. The second stage is defined in the embodiment in accordance with an example of a Correspondence Approximation and Refinement Block, which is trained using a (novel) Locality-Constrained Repellence Loss and with a view to directly honing only the selected correspondences.

A Revisit of Masked Image Modeling. Masked Image Modeling (MIM) is an SSL paradigm that involves the reconstruction of the original image from the unmasked patches. Taking MAE of He et al. as an example, given an input image x, the encoder first divides the image into non-overlapping patches x^{p} with positional embedding added to them. A class token is appended to the patch tokens but will not be affected by the following masking procedure. A binary mask M is randomly sampled to determine the masked out regions. The unmasked patches are denoted by \hat{x}^{p}=x^{p}ºM where º symbolizes the Hadamard product, and are processed by the encoder to output the patch embeddings \hat{f}^{p}. Finally, MAE uses a special embedding [ [symbol] ] to fill in the masked positions, f^{p}=\hat{f}^{p}+[ [symbol] ]º(1−M), and reconstruct x from f^{p} by minimizing the pixel-level mean squared error via a light-weight decoder. The reconstruction task requires the network to capitalize on the limited semantic context provided by the unmasked patches and the supplied positional information. This encourages the network to forge discriminative features that are optimal for differentiating and localizing the important landmark regions.

Setup for Selective Correspondence: Attentive-Inattentive Separation. The second stage 204 of framework 200 aims to establish local correspondences effectively to ensure that the representations reflect the extent of similarity and dissimilarity between the different facial regions. To achieve this, the second stage seeks to execute selective correspondence, i.e., the elimination of the direct refinement of unimportant non-landmark correspondences, and focus on optimizing those that are critical for landmark disambiguation. In an embodiment, a first step identifies potential landmark and non-landmark regions. Due to the observable opposing nature of facial landmarks (sparse and distinct) and non-landmark regions (dense and uniform), it is hypothesized (without restriction) that the landmarks are coarsely distinguishable using the first stage backbone features.

With reference again to the embodiment of FIG. 2, it is noted that first stage 202 is a pretrained ViT backbone that is frozen (i.e. not further trained once its initial training is complete), and from which the pretrained decoder is removed leaving the trained encoder components. Input x 206 is provided to first stage 202 of MAE and a patchify block 208. Examples of input x and a “patchified” x are figuratively shown at 206A and 208A respectively and further represented as a token grouping (e.g. 212A) of attentive tokens (e.g. 213A) and a class (CLS) token (e.g. 211B) as further described below. Tokens 212A are supplemented with positional embeddings e.g. using an element-wise add function.

First stage 202 comprises a plurality of (ViT) transformer blocks as an encoder layer 214 outputting a token grouping (e.g. 212B) of the attentive tokens and the CLS token. At 216, a CLS similarity block processes token grouping 212B and outputs a grouping (e.g. 212C) of attentive tokens, inattentive tokens and a CLS token. Further output is an attentive mask 218. In an embodiment, an all-pairs attentive mask M of size P×P, where P is the number of tokens, stores a 0 (inattentive) or 1 (attentive) signifying a token type after the attentive-inattentive separation. An entry (i,j) represents the correspondence type between the token pair at (i,j). Based on the token-pair type, a repellence coefficient matrix is constructed in an embodiment as described below. The matrix is useful for the loss based training but not used after training, for example, when second stage 204 training is complete.

Clustering block 220 processes grouping 212C to output a grouping (e.g. 212D) comprising cluster centers, attentive tokens and the CLS token. A final encoder layer block 220 processes grouping 212D for providing to second stage 204 (e.g. as cluster centers, attentive tokens and the CLS tokens (not illustrated)). Thus through the processing, the MAE patch tokens are split into attentive tokens (shown as lined circles) and inattentive tokens (shown as lined circles with an X) based on similarity to the CLS token (shown as a black circle). The inattentive tokens are clustered into K cluster centers (e.g. shown as a black square or a lined square as example clusters in grouping 212D, though more than 2 such centers may be determined). Further details are provided below.

The CLS token (e.g. 213B) represents the image and is obtained by aggregating information from the other patch tokens over several layers. Since landmarks are sparse and have more distinct texture, there is an expectation (without restriction) that the corresponding tokens have a large influence on the CLS token representation. The first stage block (i.e. MAE framework as pretrained and frozen) used to train the second stage 204 is configured, in an embodiment, to compute a similarity vector between the CLS token and all patch tokens as:

$$S i {m}_{cls} = Softmax ( \frac{K \cdot {q}_{cls}}{\sqrt{d}} ) ∈ {ℝ}^{N} , \qquad ( 1 )$$

where q_{cls}, K, d, and N denote the CLS token query vector, the patch token key matrix, latent dimension, and number of patch tokens respectively. Here, q_{cls}∈ [symbol] ^{d} and K∈ [symbol] ^{N×d}. The N patch tokens are split into two groups: (1) attentive group, consisting of the n. N tokens that have the highest similarity score with the CLS token, and (2) inattentive group, consisting of the remaining (1−n)·N tokens. Here, n is a hyperparameter between 0 and 1. It is observed that the inattentive tokens mostly cover non-landmark face regions (e.g. see FIG. 2 at 222), such as cheeks and forehead, as well as background. Henceforth, it is presumed (without restriction) that attentive tokens cover the landmark and important facial regions, while inattentive tokens correspond to unimportant non-landmark regions.

Inattentive Token Clustering. Since several inattentive tokens often correspond to the same facial region (e.g., cheek, forehead, etc.), the downstream correspondence objectives associated with them would likely be redundant. By applying a clustering algorithm on the inattentive tokens, numerous non-landmark regions can be represented with only a handful of cluster centers. Selective correspondence can then be set up by discarding all non-cluster center tokens, ensuring that no correspondence is established with them.

In an embodiment, there is adopted a simple density peak clustering algorithm (Long, Sifan, Zhen Zhao, Jimin Pi, Shengsheng Wang, and Jingdong Wang. “Beyond attentive tokens: Incorporating token importance and diversity for efficient vision transformers.” In Proceedings of the IEEE/CVF Conference on Computer Vision and Pattern Recognition, pp. 10334-10343. 2023, which is incorporated herein by reference in its entirety), wherein two variables ρ and δ are defined for each inattentive token. Here, ρᵢ measures the density of the i-th token and δᵢ computes the minimum distance from the i-th token to any other inattentive token which has a higher density. Mathematically, they are defined as:

$${ρ}_{i} = exp ( {\sum }_{{t}_{j} ∈ {T}_{inatt}} {‖ {t}_{i} - {t}_{j} ‖}_{2}^{2} ) ∈ {ℝ}^{N} , \qquad ( 2 )$$

$${δ}_{j} = \{ \begin{matrix}{min}_{j : {p}_{j} > {ρ}_{i}} {‖ {t}_{i} - {t}_{j} ‖}_{2} & if ∃ j s . t . {ρ}_{j} > {ρ}_{i} , \\ {max}_{j} {‖ {t}_{i} - {t}_{j} ‖}_{2} & otherwise\end{matrix} \qquad ( 3 )$$

where tᵢ, tⱼ∈T_{inatt′} and Tᵢₙₐₜₜ denotes all inattentive tokens. Since the cluster center should have higher density than neighbouring tokens and should also be distant to other cluster centers, the cluster center score of the i-th token is computed by ρᵢ·δᵢ. The top-K_{c} scoring tokens are selected as cluster centers, where K_{c} is a hyperparameter. The remaining inattentive tokens are discarded and the cluster center tokens subsequently act as representative proxies for them.

Selective Correspondence using CARB. In the second stage 204 providing a Correspondence Approximation and Refinement Block (CARB), there is first substituted (e.g. at cluster approximation block 224) the discarded inattentive tokens with their corresponding cluster centers and the relevant visual features are aggregated to obtain a complete 2D feature map (e.g. 226) also visually represent at 222 in FIG. 2. With the backbone frozen, the feature map 226 is passed through a light-weight projector 230, which is supervised by a (novel) Locality-Constrained Repellence (LCR) Loss 232. As the LCR loss 232 operates on the features of attentive tokens and inattentive cluster centers, there is directly refined only the most important correspondences, thereby achieving selective correspondence. The LCR loss weakens existing erroneous correspondences in a weighted manner by considering the token-pair proximity (locality) and correspondence type (repellence) constraints (e.g. from the attentive mask 218).

Locality-Constrained Repellence (LCR) Loss. The LCR loss 232 is designed and operated to yield high-fidelity fine-grained features by optimally refining local correspondences. Henceforth, Tₐₜₜ and T_{inatt′} denote the attentive and the approximated inattentive tokens (cluster centers) respectively, and define and T=Tₐₜₜ∪T_{inatt′} as the set of all considered tokens.

Correspondence can be formally defined as the probability that a patch token tⱼ corresponds to a patch token tᵢ in the image x, which is expressed as:

$$p ( {t}_{i} \vert {t}_{j} ; Φ , x ) = \frac{exp ( 〈 {Φ}_{{t}_{i}} ( x ) , {Φ}_{{t}_{j}} ( x ) / τ 〉 )}{{\sum }_{{t}_{k} ∈ T} exp ( 〈 {Φ}_{{t}_{i}} ( x ) , {Φ}_{{t}_{k}} ( x ) / τ 〉 )} , \qquad ( 4 )$$

where Φₜ_{ᵢ}(x) is the final projected feature representation of patch tᵢ, and τ is the temperature parameter.

It is observed that image patches that are spatially distant from each other often correspond to different facial regions. Hence, it should follow that strong correspondences between distant patches are likely to be erroneous and should be discouraged. A locality constraint is computed to formalize this idea using the following function:

$${f}_{loc} ( {t}_{i} , {t}_{j} ) = log ( ‖ {t}_{i} - {t}_{j} ‖ + 1 ) , \qquad ( 5 )$$

where tᵢ, tⱼ∈T, and ∥·∥ computes the spatial distance. The log function saturates the coefficient in order to discourage the network from excessively focusing on separating very distant correspondences. Although a similar constraint was introduced in Thewlis, James, Hakan Bilen, and Andrea Vedaldi. “Unsupervised learning of object frames by dense equivariant image labelling.” Advances in neural information processing systems 30 (2017), which is incorporated herein in its entirety, the primary motive was to avoid collapse during equivalence learning.

Considering the attentive and the approximated inattentive token sets (Tₐₜₜ and T_{inatt′}), there are three types of correspondences: attentive-attentive (att-att), attentive-inattentive (att-inatt), and inattentive-inattentive (inatt-inatt). There is introduced a repellence coefficient to quantify the importance of each correspondence type:

$${λ}_{rep} ( {t}_{i} , {t}_{j} ) = \{ \begin{matrix}{Γ}_{att - att} & if {t}_{i} , {t}_{j} ∈ {T}_{att} \\ {Γ}_{inatt - inatt} & if {t}_{i} , {t}_{j} ∈ {T}_{inatt} \\ {Γ}_{att - inatt} , & otherwise\end{matrix} , \qquad ( 6 )$$

where each coefficient r is a hyperparameter. In an embodiment in practice, Γₐₜₜ₋ₐₜₜ and Γₐₜₜ₋ᵢₙₐₜₜ are set to be higher than Γᵢₙₐₜₜ₋ᵢₙₐₜₜ to aim to prioritize facial landmark differentiation and landmark vs non-landmark disambiguation over non-landmark differentiation respectively. The attentive mask can be used to determine the repellence coefficient for specific token pairings. In an embodiment, for an all-pairs matrix determined from mask M, an attentive-attentive (att-att) pairing can store Γₐₜₜ₋ₐₜₜ, an attentive-inattentive (att-inatt) pairing can store Γᵢₙₐₜₜ₋ᵢₙₐₜₜ, and inattentive-inattentive (inatt-inatt) pairing can store Γₐₜₜ₋ᵢₙₐₜₜ.

Combining all of the above defined components, the LCR loss is expressed mathematically as:

$${ℒ}_{LCR} = {\sum }_{{t}_{i} ∈ T} {\sum }_{{t}_{j} ∈ T} {f}_{loc} ( {t}_{i} , {t}_{j} ) \cdot {λ}_{rep} ( {t}_{i} , {t}_{j} ) \cdot p ( {t}_{i} \vert {t}_{j} ; Φ , x ) , \qquad ( 7 )$$

The LCR loss aims to forge effective local features by systematically weakening erroneous, spatially distant correspondences among and between the important and unimportant patch tokens.

Inference. After training, optimized representations for all image regions are obtained. Hence, during inference, the clustering and inattentive token approximation procedures are by-passed (e.g. turned off) and only the original features for the downstream tasks are utilized.

As training of the second stage is complete, calculating the correspondence is not necessary with a trained network. During training token type separation and clustering and token-pair correspondences were calculated and refined to train the network to differentiate between tokens of different face parts.

In an embodiment, a final network comprises the first stage and second stage as trained (i.e. the MAE based encoder and the projector network), for example to provide a network for landmark matching. In an embodiment, regressor components are coupled to the projector network as trained, and this network is further trained to perform landmark regression (e.g. See FIG. 6).

Additionally, in an embodiment such as for fair comparison purposes against prior works, spatial expansion is performed for the size of the feature input to the projector. Naively decreasing the patch size to expand the output not only quadratically increases the computation and memory costs but also may lead to the formation of inferior feature representations. Instead, a cover-and-stride technique is adopted to produce more fine-grained and rich expanded representations.

Experiments. Datasets. The backbone (stage 1) was pretrained on the CelebA dataset (of Liu et al.), which contained 162,770 images. Face landmark detection is evaluated on four datasets: MAFL (of Zhang et al.), 300 W (of Sagonas et al.) and two variants of AFLW (of Koestinger et al.) MAFL consisted of 19,000 training images and 1,000 test images. 300 W had 3148 training images and 689 test images. AFLW_{M} contained 10,122 training images and 2995 testing images, which are crops from MTFL (of Zhang et al.) AFLW_{R} contained tighter crops of face images where the training and test set had 10,122 and 2,991 images respectively. Note that 300 W provided 68 annotations per image while the other three datasets only provided 5 annotations.

Re-annotation. Although the AFLW_{R} has been used in prior works, the fidelity of the annotations are questionable. These annotation errors include errors arising due to semantic mismatches, translations, and random shifts. For a more consistent and reliable evaluation, the AFLW_{R} test set was re-annotated. In the following sections, AFLW_{RO} and AFLW_{RC} are used to denote the original and corrected dataset respectively.

Implementation Details. In embodiments, models were pretrained on the CelebA dataset using MAE with three backbones: DeiT-T, DeiT-S and DeiT-B. All models were trained for 400 epochs with a batch size of 512, a learning rate of 3e−4 and patch size of 8. The image was resized to 136×136 and the center 96×96 cropped as input for both landmark matching and regression. The attentive rate n was set to 0.25 for DeiT-B and 0.1 for DeiT-T and DeiT-S. Clustering was applied after the third encoder layer and the number of clusters K_{c} set to 4. For the LCR loss, the three repellence hyperparameters were set to Γₐₜₜ₋ₐₜₜ=5, Γₐₜₜ₋ᵢₙₐₜₜ=5, and Γᵢₙₐₜₜ₋ᵢₙₐₜₜ=2. Ablation studies were performed. Although DeiT based backbones were employed, others types of ViT frameworks (e.g. BeiT) may be used and trained accordingly.

Landmark Matching: Evaluation Protocol. 1000 reference-and-test image pairs were generated from the MAFL test set for evaluation. The first 500 pairs served as the benchmark for landmark matching between same identities, which contained the original image and its thin-plate-spline (TPS) deformed counterpart. The other 500 pairs were of different identities. During evaluation, all feature maps were bi-linearly up-sampled to the image resolution. Landmark representations of the reference image were used to query the test image. The location with the highest cosine similarity was considered as the matched prediction. Finally, the Mean Pixel Error was computed between the prediction and ground-truth.

Quantitative Results. The framework herein (e.g. in three embodiments) was compared with existing SOTA frameworks as shown in Table 1 by grouping the results based on the final feature size. The best and second best results are shown in bold and underline respectively Three different backbones were used (e.g. in the embodiments) to control the number of parameters for a fair comparison. In the first group, the embodiment of the model with DeiT-T, being a fraction of the size of prior works, already outperforms the SOTA. In the second and third group, the embodiments visibly outperform prior works by large margins of ˜20% and ˜44% for the same and different identities respectively. This is attributed (without restriction) to the highly potent initial features from the MAE pretraining, which, when strategically refined through selective correspondence using CARB, yields distinctive final features that were vital for successful landmark matching.

TABLE 1

| | | | | |
|---|---|---|---|---|
| Framework | #Param. | Feat. | Same | Diff. |

| | | | |
|---|---|---|---|
| (Method) | Millions | Dim. | Mean Pixel Error |

| | | | | |
|---|---|---|---|---|
| DVE | 12.4 | 64 | 0.92 | 2.38 |
| CL | 23.8 | 64 | 0.92 | 2.62 |
| LEAD | 23.8 | 64 | 0.51 | 2.60 |
| DeiT-T | 5.4 | 64 | 0.47 | 1.99 |
| CL | 23.8 | 128 | 0.82 | 2.19 |
| DeiT-S | 21.4 | 128 | 0.31 | 1.69 |
| CL | 23.8 | 256 | 0.71 | 2.06 |
| LEAD | 23.8 | 256 | 0.48 | 2.50 |
| DeiT-S | 21.4 | 256 | 0.33 | 1.72 |
| DeiT-B | 85.3 | 256 | 0.27 | 1.61 |

Qualitative Results. Landmark matching results between different identities were visualized (not shown) and compared with existing SOTA methods. The mismatches on different landmarks when using CL and LEAD were shown in different columnar groups, e.g., the first group of three columns contained eye-related mismatches. The framework method of the embodiments herein clearly achieved a more accurate matching performance across all landmarks even on difficult examples such as those wearing eye-glasses. Admittedly, the framework method of the embodiments herein experienced some failures when the poses of reference and test samples are vastly dissimilar or when landmark regions are severely occluded.

Landmark Detection: Evaluation Protocol. The pretrained backbone and projector were frozen, and only a light-weight regressor was trained. The regressor in accordance with the embodiment herein comprises a convolution block (instead of a linear layer) and a linear layer when training on all annotated samples. The convolution block utilizes the spatial context to produce I intermediate heatmaps for each landmark which are converted to I pairs of 2D coordinates by a soft-argmax operation and fed to a linear layer that outputs the final landmark prediction. For all experiments, I=50. The first and second stage concatenated features are leveraged as a more robust input to the regressor on the expectation that the backbone provides rich task-agnostic representations during the first stage and the projector supplements task-specific cues critical for landmark detection during the second stage.

All Annotated Samples. The framework method of the embodiments was compared with prior works on landmark detection benchmarks as shown in Table 2 (e.g. Quantitative evaluations on landmark detection with all annotated samples). The comparison to the existing SOTA reports the error as the percentage of inter-ocular distance on four human face datasets: MAFL, AFLW_{M}, AFLW_{R} and 300 W. For AFLW_{R}, the results are reported on both the original (AFLW_{RO}) and corrected (AFLW_{RC}) datasets. The embodiments of the framework herein, despite using significantly smaller features by avoiding expensive hypercolumns, outperform prior works on all four datasets, even with the embodiment having the smallest backbone, DeiT-T. Considering the best results of the embodiments of the framework method, the framework method achieves ˜9%-15% performance gain across different benchmarks.

TABLE 2

| Framework | #Params. | Feature | Hypercol. | MAFL | AFLW_{M} | AFLW_{RC} | AFLW_{R}_{_{C}} | 300 W |
|---|---|---|---|---|---|---|---|---|
| (Method) | Millions | Dim. | Used | Inter-ocular Distance (%), | | | | |
| DVE | 12.6 | 64 | N | 2.76 | 6.96 | 6.33 | 5.58 | 4.58 |
| CL | 23.8 | 3840 | Y | 2.76 | 6.17 | 5.69 | 5.06 | 4.84 |
| LEAD | 23.8 | 3840 | Y | 2.44 | 6.05 | 5.71 | 5.11 | 4.87 |
| DeiT-T | 5.4 | 256 | N | 2.20 | 5.89 | 5.54 | 4.86 | 4.22 |
| DeiT-S | 21.4 | 512 | N | 2.08 | 5.33 | 5.40 | 4.69 | 3.94 |
| DeiT-B | 85.3 | 1024 | N | 2.07 | 5.23 | 5.33 | 4.60 | 3.95 |

Such a compelling performance is an attestation to the discriminative ability of the features, which provide intricate disambiguation cues to the regressor for locating landmarks. It is also highlighted that all methods achieve lower error with the re-annotated AFLW_{RG′} test set, hence confirming the higher annotation quality.

Limited Annotated Samples. The embodiments of the framework herein were compared with prior works on landmark detection under different annotation settings on the AFLW_{M} dataset. Table 3 (e.g. Quantitative evaluations on landmark detection with limited annotated samples) reports the error as the percentage of inter-ocular distance. The embodiments of the framework outperformed all existing SSL-based methods with significant performance gain under all annotation and feature dimension settings. Specifically, a relative gain of 8.6% on average and as high as 20.1% was achieved compared to the existing SOTA. Furthermore, a smaller standard deviation was observed with repeated experiments, indicating that the framework herein produces optimal features more consistently, hence attesting to its robustness.

TABLE 3

| | Feat. | Number of Annotated | | | | | |
|---|---|---|---|---|---|---|---|
| Method | Dim. | 1 | 5 | 10 | 20 | 50 | 100 |
| DVE[46] | 64 | 14.23 ± 1.45 | 12.04 ± 2.03 | 12.25 ± 2.42 | 11.46 ± 0.83 | 12.76 ± 0.53 | 11.88 ± 0.16 |
| CL[9] | 64 | 24.87 ± 2.67 | 15.15 ± 0.53 | 13.52 ± 1.08 | 11.77 ± 0.68 | 11.57 ± 0.03 | 10.06 ± 0.45 |
| LEAD[19] | 64 | 21.80 ± 2.54 | 13.34 ± 0.43 | 11.50 ± 0.34 | 10.13 ± 0.45 | 9.29 ± 0.41 | 9.11 ± 0.25 |
| SCE-MAE | 64 | 18.41 ± 1.21 | 11.79 ± 0.44 | 10.57 ± 0.24 | 9.65 ± 0.14 | 8.60 ± 0.17 | 831 ± 0.06 |
| CL[9] | 128 | 27.31 ± 1.39 | 18.66 ± 4.59 | 13.39 ± 0.30 | 11.77 ± 0.85 | 10.25 ± 0.22 | 9.46 ± 0.05 |
| LEAD[19] | 128 | 21.20 ± 1.67 | 13.22 ± 1.43 | 10.83 ± 0.65 | 9.69 ± 0.41 | 8.89 ± 0.20 | 8.83 ± 0.33 |
| SCE-MAE | 128 | 20.14 ± 1.76 | 11.99 ± 0.71 | 10.40 ± 0.22 | 9.25 ± 0.14 | 8.49 ± 0.19 | 7.96 ± 0.21 |
| CL[9] | 256 | 28.00 ± 1.39 | 15.85 ± 0.86 | 12.98 ± 0.16 | 11.18 ± 0.19 | 9.56 ± 0.44 | 9.30 ± 0.20 |
| LEAD[19] | 256 | 21.39 ± 0.74 | 12.38 ± 1.28 | 11.01 ± 0.48 | 10.06 ± 0.59 | 8.51 ± 0.09 | 8.56 ± 0.21 |
| SCE-MAE | 256 | 17.08 ± 1.35 | 11.28 ± 0.54 | 10.30 ± 0.09 | 8.95 ± 0.08 | 8.20 ± 0.20 | 7.58 ± 0.09 |

Ablation Studies: Importance of Each Component. To better understand the proposed SCE-MAE framework, the component-wise ablation analysis on the landmark matching task is reported in Table 4. The first three rows indicate the usage of only the first-stage backbone features, while the last two rows, respectively, indicate the inclusion of clustering and LCR loss in the proposed framework. CL and LEAD utilize hypercolumns whereas the proposed framework leverages the vanilla last layer features of the pretrained MAE, which is indicated as Baseline. Using the backbone alone, the baseline outperforms CL and LEAD, validating the motivation that MIM is a more suitable pretext task for landmark representation learning. It is observed that the clustering assists the matching between the same identity while the LCR loss boosts the matching performance between different identities. Overall, these trends align with the expectations: initially, the region-level first-stage MAE features capture local intricacies but are too raw to generalize the landmarks across different identities; the clustering disambiguates the landmarks from the unimportant regions, which improves the same identity matching performance; and finally, the LCR loss forges critical local correspondences between important facial regions, resulting in the best performance for both settings.

TABLE 4

| | |
|---|---|
| Same | Diff. |

| | | | |
|---|---|---|---|
| Method | Cluster | [symbol] _{LCR} | Mean Pixel Error |

| | | | | |
|---|---|---|---|---|
| CL | — | — | 0.69 | 5.37 |
| LEAD | — | — | 2.35 | 6.22 |
| Baseline | N | N | 0.55 | 3.51 |
| SCE-MAE | Y | N | 0.30 | 4.04 |
| | Y | Y | 0.27 | 1.61 |

Visualization of Landmark Representations. The t-SNE plots 300 of the landmark representations corresponding to 1000 test images are visualized in FIG. 3. Since LEAD only performs knowledge distillation in its second stage, the first-stage hypercolumn representations were used as it can be considered as the upper bound of the second-stage objective. For each method, t-SNE is executed 00 times and the mean and standard deviation of the Silhouette Coefficient, a metric (higher is better) indicating the quality of the clustering as a function of the mean intra-cluster (lower is better) and inter-cluster (higher is better) distance are reported. For CL, the samples within the cluster (e.g. 302) are more scattered, resulting in a higher intra-cluster distance. For LEAD, though the clusters are denser, the clusters of the left/right lip corner 304A/304B and nose 306 are not clearly separated, resulting in a lower inter-cluster distance. Plots from an SCE-MAE embodiment herein result in both well-separated and dense clusters, which is reflected by a high Silhouette Coefficient, thereby corroborating the superior quality of such landmark representations.

In accordance with an embodiment, a trained landmark detection network in accordance with the proposed framework herein is configured as a component of an effects pipeline, for example, a makeup effects pipeline. The trained landmark detection network can form a component of a face tracking engine. The pipeline can be provided as a component of a virtual try on (VTO) application to simulate the application of an effect, e.g. a makeup effect to a face image. The image may be a still image or an image (e.g. a frame) of a video. As earlier noted, a trained landmark detection network may be configured as a component of other downstream applications, such as 3D face reconstruction, face recognition, face emotion/expression recognition, and more contemporary applications such as facial beauty prediction. A VTO application is further described.

Downstream Applications. In accordance with embodiments of the prior art, an effects rendering pipeline (e.g. a flow of operations of a computing device) can be configured to apply an effect to an image such as an effect that simulates a product or service using the facial landmarks. In an embodiment the effect simulates a product or service applied to the face to provide a virtual try on (VTO) experience.

The product can be a makeup product or an appliance product (e.g. eyewear, hearing aids, appliances for the teeth including braces, etc.); and the service comprises a cosmetic procedure or a surgical procedure or other face altering procedure (e.g. changing shape, size, color, etc. of a facial feature). The

In an embodiment, a facial landmark detection network is a component of or communicates with an application and facial landmarks determined by the network are provided for further use by the application. The application may comprises any of a VTO application; a teleconsultation application, a video chat application, a video conference application, or a facial recognition application, among others.

FIG. 4 is a block diagram of operations of a single threaded effects pipeline in accordance with a prior art embodiment. Pipeline 400 comprises a single thread 402. A current frame to be processed is denoted as frame t. An immediately previous frame that was processed is denoted as frame t−1 and an immediately next frame to be processed is denoted as frame t+1. Frame t is received at operations 404 for processing sequentially at operations 406 such as by a landmark detection component (e.g. of a face tracking engine). Thereafter, an effects rendering component processes effects at operations 408 to produce frame t for output at operations 410, where at output frame t is with one or more effects applied, for example.

The face tracker comprises, in an embodiment, one or more neural networks for such a purpose, for example, a network in accordance with framework 200 of FIG. 2.

In an embodiment, the face tracker is adapted to track (i.e. localize) classes of objects related to a face, including a face object itself. Output from such a face tracker can comprises a bounding box or mask or other structure to derive a cropped frame (e.g. a cropped face image). In a cropped frame, for example, any background in the frame, such as frame t, is minimized. FIG. 5A shows representative frame t 500 (an example of a face image 502) including a face 504 and background 506. Background may comprise other portions of the subject as well as non-subject portions. A bounding box 508 shown as a dotted line box shows coordinates for defining a cropped image including face 504 and minimized background content (some of background 506).

In embodiment, the landmark detection component or face tracker is configured to determine (e.g. predict) a location of a face in a frame and locations within the face of one or more facial landmarks (e.g. semantic facial features) of the face. In an embodiment such features comprise a face contour (e.g. portions of a jawline, chin or both), a nose, an inner mouth, an outer mouth, a left eye, a right eye, a left brow and a right brow such as is shown in FIG. 5B.

FIG. 5B is an illustration of output of a face tracker of an effects pipeline showing a cropped face image 510 of a face 504, such as described, and face points 512 in accordance with an embodiment. Respective groups of face points 512 comprise, in an embodiment, face contour face points 512A, eyebrow face points 512B, and nose face points 512C, etc., for each object for which face points are determined. The depiction is of an annotated cropped face image 510 with the groups of the face points for purposes of illustration. The face tracker output need not comprise an annotated image and the output can be separate data. The face points in an individual group are numbered or indexed (e.g. 0, 1, 2, . . . ) and assist with defining the contour of the detected object. The face tracker assigns each point so that it is placed at consistent locations relative to the contour of the object it is denoting. For example, a particular point might always be at a right corner of the mouth. In an example, the face points are X,Y pixel coordinates, relative to the cropped face image 510 and are associated with respective detected objects from (e.g. one of) the networks of a face tracker.

FIG. 6 is an illustration of a computing environment 600, in accordance with an embodiment, such as for practicing one or more method aspects, for example, including but not limited to VTO operations. Computing environment 600 shows a user computing device 602, such as a smartphone, a communications network 604, a server 606 and a server 608. Communications network 604 comprises wired and/or wireless networks, which may be public or private and may include, for example the internet. Server 606 comprises a server computing device such as for providing a website. Server 608 comprises a server computing device such as for providing e-commerce transaction services. Though shown separately, the servers 606 and 608 can comprise one server device. Computing environment is simplified. For example, not shown are payment transaction gateways and other components such as for completing an e-commerce transaction.

Computing device 602 comprise a storage device 610 (e.g., a non-transient device such as a memory and/or solid state drive, etc.) for storing instructions that, when executed by a processor (not shown), cause the computing device 602 to perform operations such as a computer implemented method. Storage device 610 stores a virtual try on application 612 comprising components such as software modules providing, a user interface 614, face tracker 616, with one or more neural networks 618 configured for face detection including determining face points, a VTO rendering pipeline component 620 with a stabilization component 622, a product recommendation component 624 with product data 626, and a purchasing component 628 with shopping cart 630 (e.g. purchase data). One of the one or more neural networks 618 comprises a network according to the two stage framework, for example, in an embodiment, comprising a first stage having an MIM backbone, or in an embodiment comprising a first stage having an MIM backbone (such as MAE of first stage 202) and a second stage (e.g. 204) implementing selective correspondence as described herein and/or as trained as described herein. In an embodiment, the second stage is a projector network configured to include or couple to a regressor 619.

In an embodiment, VTO application is a web-based application such as is obtained from server 606. Though not shown, user device 602 may store a web-browser for execution of web-based VTO application 612. In an embodiment, VTO application 612 is a native application in accordance with an operating system (also not shown) and software development requirements that may be imposed by a hardware manufacturer, for example, of the user device 602. The native application can be configured for web-based communication or similar communications to servers 606 and 608, as is known.

FIG. 6 shows various input and output data or information associated with a use of VTO application 612, for example. Such includes an input image 640 of the user to be processed for a VTO experience, an output image 642 to which product effects are simulated providing a VTO experience, a VTO product selection 650 comprising user input selecting one or more product effects to be simulated, VTO products options 652 comprising options for products to be virtually tried on, for example for selection by a user of device 602, and purchase transaction information 660 comprising purchase information provided to and/or received from a user to purchase a product.

In an embodiment, via one or more of user interfaces 614, VTO product options 652 are presented for selection to virtually try on by simulating effects on an input image 640. In an embodiment the VTO product options 652 are derived from or associated to product data 626. In an embodiment, the product data 626 can be obtained from server 606 and provided by the product recommendation component 624. Though not shown, user or other input may be received for use to determine product recommendations. The user may be prompted, such as via one of interfaces 614 to provide input for determining product recommendations. In an embodiment, the product recommendation component 624 communicates with server 606. Server 606, in an embodiment, determines the recommendation based on input received via component 614 (e.g. and 624) and provides product data accordingly. User interface 614 can present the VTO product choices, for example, updating the display of same responsive to the data received as the user browses or otherwise interacts with the user interface 614.

In an embodiment, the one or more user interfaces 614 provide instructions and controls to obtain the input image 640, and VTO product selection input 650 such as an identification of one or more recommended VTO product options 652 to try on. In an embodiment, the input image 640 is a user's face image, which can be a still image or a frame from a video. In an embodiment, the input image 640 can be received from a camera (not shown) of device 602 or from a stored image (not shown). The input image 640 is provided to face tracker 616 such as for processing to detect objects in the face image using one or more deep neural networks 618 as trained. In an example, the network classifies, localizes or segments for a facemask (or other occluding object) in the image. In an embodiment, example classification for facemask presence is useful to output a request (e.g. an instruction to a user such as via user interfaces 614), to lower or remove a facemask. Such is applicable to any occluding object for which the face tracker engine is trained. In an embodiment, occlusion can be handled at rendering, such as described herein, to avoid rending over an inclusion.

In an embodiment, output (specifics not shown) from the face tracker 616, such as classification results, localization results or segmentation results for one or more detected objects, is provided to VTO rendering pipeline component 620. In an example, the output may comprise a bounding box e.g. 508 of FIG. 5A and, as shown in FIG. 5B, face points 512 (e.g. groups thereof) for detected objects, etc. Input image 640 is also provided (e.g. made available) to VTO rendering pipeline component 620. The VTO product selection 630 is also provided to VTO rendering pipeline component 620 for determining which effects are to be rendered. In an embodiment related to makeup simulation, one or more effects can be indicated such as for any one or more of the product categories comprising: lip, eye shadow, eyeliner, blush, etc.

VTO rendering pipeline component 620, in an embodiment, determines whether to render one or more product effects to the input image 640 to simulate a try on. For example, responsive to facemask classification output, VTO rendering pipeline component 620 can determine not to render a product effect, for example, because a mask (an occlusion) is detected. When a facemask is detected, for example, VTO rendering pipeline component 620 can, optionally, trigger the user interface 414 to ask the user to remove the facemask. A new image (new instance of image 640) can be received and processed by face tracker 616. In an embodiment, images are continuously received as a component of a live stream (e.g. a selfie video). In an embodiment, occlusions are dealt with at rendering so as to avoid rendering over an inclusion, such as described herein.

If VTO rendering pipeline component 620 determines to render the one or more product effects, in an embodiment VTO rendering pipeline component 620 renders effects on the input image 640 such as by drawing (rendering) effects in layers, one layer for each product effect, to produce output image 642. Portions of the operations of VTO rendering pipeline component 620 (e.g. such as for drawing the layers) can be performed by a graphics processing unit, in an embodiment. The rendering is in accordance with product data 626 as selected by VTO product selection 650 and is responsive to the location of detected objects. For example, a VTO product selection of a lipstick, lip gloss or other lip related product invokes the application of an effect to one or more detected mouth or lip-related objects at respective locations. Similarly a brow related product selection invokes the application of a selected product effect to the detected eye brow objects. Typically, for symmetrical looks, the same brow effects are applied to each brow, the same lip effect to each lip or the same eye effect to each eye region, but this need not be the case. In an example, the rendering is applied to a region that is relative to the detected objects, such as adjacent one or more such detected objects. Some VTO product selections comprise a selection of more than one product (e.g. defining a “look”) such as coordinated products for brows and eyes or other combinations of detected objects, including the whole face. Product data can define respective “looks” grouping associated products, for example, and associating the look with a name for display via the user interface, such as displayed associated with a control enabling user selection of a look from a group of looks in presented in a list, array or other presentation format. VTO rendering pipeline component 620 can render each effect, for example, one at a time until all effects are applied. The order of application can be defined by rules or in the selection of products e.g. lipstick before a top gloss.

In an embodiment where an occluding object is detected and the location is determined, for example, as represented in a segmentation mask, the rendering can be responsive to such a segmentation mask. Rendering of an effect can be applied to portions of the face that are not occluded. A segmentation mask can indicate the pixels of the face that are available to (e.g. may) receive an effect such as a makeup effect and those pixels that are not available to receive an effect.

User interface 614 provides the output image 642. Output image 642, in an embodiment, is presented as a portion of a live stream of successive output images (each an example of image 642) such as where a selfie video is augmented to present an augmented reality experience. In an embodiment, output image 642 is presented along with the input image 640, such as in a side by side display for comparison. In an embodiment, output image 642 can be saved (not shown) such as to storage device 610 and/or shared (not shown) with another computing device.

In an embodiment, (not shown) the input images comprise input images of a video conferencing session and the output images comprise a video that is shared with another participant (or more than one) of a video conferencing session. In an embodiment the VTO application is a component or plug in of a teleconsultation application or a video conferencing application (each not shown) permitting the user of device 602 to wear makeup during a teleconsultation or video conference (respectively) with one or more other conference participants.

In an embodiment, VTO rendering pipeline component 620 is configured to apply object stabilization (e.g. using stabilising component 622) to stabilize respective locations of detected objects between, for example, successive frames of a video.

In an embodiment, face tracker 616 localizes facial features but without detecting facemask (or other occluding object) presence. As a result, in such an embodiment, the operations of VTO rendering pipeline component 620 are configured without accounting for occlusions.

In accordance with an embodiment (not shown), an application for performing a teleconsultation or video chat or video conference incorporates an integrated virtual try on such that a user can appear to have selected makeup effect during a chat or conference. It will be a similar environment to environment 600 can be configured. In a video chat or video conference environment, a user device provides a teleconsultation or video conferencing application having integrated VTO features. Application is stored to a non-transient storage device. Integrated VTO features are provided such as by the components of a VTO application.

The user device is configured to communicate with a server providing video chat or conferencing services thereby to communicate with one or more other user devices. Examples of platforms providing a video conferencing service, which are not to be limiting, include MICROSOFT TEAMS™ available from Microsoft Corporation of Redmond, WA; ZOOM ONE™ available from Zoom Video Communications, Inc. of San Jose, CA; and GOOGLE MEET™, available from Google LLC of Mountain View Parkway, among others.

In brief, teleconsultation or video conferencing services permit sharing of live video between two or more user devices communicating via an intermediary device, namely a server. A first user device obtains a video stream from a camera (either an internal or external camera coupled thereto) and provides it to server for communication to other participant devices (e.g. and their respective users (e.g. conference members in video conferencing, a clinician or beauty advisor in teleconsultation)) that are participating in the conference as maintained by the conference or chat server. Such a server provides respective video streams received from the respective user devices to other user device for the conference or chat. It is understood that the server may process (e.g. perform video processing of) any of the video streams it receives and retransmits for a conference or teleconsultation.

Respective user teleconsultation or video conference applications executing on the respective devices can be configured to present the received video streams such as in accordance with a selected layout or view in a user interface on a display device. A layout or view may show a member who is the active speaker or a pinned conference member or all conference members, etc. as is known.

In an embodiment, the conference or chat application is configured to apply at least one effect to the images originated by the user device, enabling a virtual try on during the teleconsultation or video conferencing meeting, so that other members receive the output images as rendered using the integrated VTO application with the at least one effect applied.

An input image represents a frame of an input video stream originated from a camera local to the user device while an output image represents a frame of an output video stream determined from one or more frames of the input video stream. Each output image is presented in accordance with the user interface or other controls of the application. Thus at sometimes during the teleconsultation or conference, the output image may not be displayed by the user device such as when another member has a focus and only that member's stream is being presented. However, the output image is communicated to the server for retransmission for (e.g. selective) display by other user devices according to the respective controls of their local teleconsultation or video conference applications. It is understood that no VTO effects are applied if the camera control is “off” and no camera images are shared out to server.

In an embodiment, the teleconsultation, conference or chat application is configured with user interfaces having controls to enable a user to select whether to have a VTO effect applied. In an embodiment, the user interface is enabled to receive user input to select a preview of an effect(s), invoking the VTO components to process the input video stream and render an output video stream with the effect(s) rendered for display by the user's device. In an embodiment, during the preview, the output video stream is not shared to the server and thus not provided to other devices during the period of the preview. In embodiment, the user interface is enabled to present detailed information about each of the products of the effects and further enabled to permit purchasing of products.

In this work, there is disclosed, a two-stage framework to tackle the self-supervised face landmark estimation tasks. To learn effective and locally distinct representations, there is targeted structured improvements on both stages. For the first stage, the region-level MAE is utilized instead of instance-level SSL methods to derive more potent initial representations. For the second stage, it is demonstrated that it is beneficial to identify important facial regions and directly hone only the salient correspondences. The disclosed approaches (e.g. in embodiments) yield discriminative and high-quality landmark representations that result in superior performance over prior SOTA works on both the landmark matching and detection tasks.

Aspects and features from the embodiments will be apparent to a person of ordinary skill in the art and include those in the following numbered statements:

Statement 1: A computer implemented method for self-supervised learning (SSL) training of a network for facial landmark detection for a face in an input image, wherein the network comprises encoder components encoding features of the face and decoder components determining local correspondences between the features for determining landmark estimates, the method comprising: training a first network comprising a Masked Image Modeling (MIM) network that processes non-overlapping patches determined from the input image with a SSL objective, wherein the encoder components comprise a portion of the MIM network to encode features of the input image for decoding; and training a second network comprising the encoder components, as trained, in series with the decoder components, the decoder components trained to determine local correspondences comprising respective relationships between the features of the input image provided by the encoder components.

Statement 2: The method of Statement 1, wherein the MIM network comprises a MAE network.

Statement 3: The method of Statement 2, wherein the MIM network, as trained, is configured to: provide respective tokens for the patches for processing by the decoder components; and combine information from tokens related to non-landmark regions of the input image to define approximated tokens, reducing the number of tokens for processing by the decoder components.

Statement 4: The method of Statement 3, wherein the MIM network, as trained, is configured to: define respective patch tokens for each patch and a class (CLS) token representing the image as an aggregation of information from the respective patch tokens; identify each patch token as an attentive token or an inattentive token in accordance with a respective similarity to the CLS token determined for each patch token; and combine information from inattentive tokens to provide approximated inattentive tokens, reducing the number of inattentive tokens for processing by the decoder components.

Statement 5: The method of Statement 4, wherein the MIM network, as trained, is configured to perform inattentive token clustering to combine the information from the inattentive tokens, defining cluster centers to represent the information.

Statement 6: The method of any one of Statements 2 to 5, wherein the MAE network is configured as a vision transformer (ViT) using self-attention mechanisms to process images.

Statement 7: The method of any one of Statements 1 to 6 comprising training a final network for landmark detection, the final network comprising regressor components configured to determine the landmark estimations features processed by the decoder components as trained, the regressor components configured in series with the decoder components as trained, and the decoder components in series with the encoder components as trained.

Statement 8: The method of any one of Statements 1 to 7, wherein the second network comprises a projector network, the decoder components comprising a portion of the projector network.

Statement 9: The method of Statement 8, wherein training the decoder components trains the projector network using a locality constrained repellence (LCR) loss.

Statement 10: The method of Statement 9, wherein the LCR operates on features of landmark regions and combined information from non-landmark regions that reduces processing to achieve selective correspondence processing for the local correspondences.

Statement 11: The method of Statement 9 or 10, wherein LCR loss is defined in accordance with:

$${ℒ}_{LCR} = {\sum }_{{t}_{i} ∈ T} {\sum }_{{t}_{j} ∈ T} {f}_{loc} ( {t}_{i} , {t}_{j} ) \cdot {λ}_{rep} ( {t}_{i} , {t}_{j} ) \cdot p ( {t}_{i} \vert {t}_{j} ; Φ , x ) , \qquad ( 7 )$$

where: f_{loc}(tᵢ, tⱼ) defines a locality constraint; λᵣₑₚ(tᵢ, tⱼ) defines a repellence coefficient, prioritizing landmark differentiation and landmark vs non-landmark disambiguation over non-landmark differentiation respectively; and p(tᵢ|tⱼ; Φ, x) defines a correspondence as a probability that a patch token tⱼ corresponds to a patch token tᵢ in the image x.

Statement 12: The method of Statement 11, wherein:

$$p ( {t}_{i} \vert {t}_{j} ; Φ , x ) = \frac{exp ( 〈 {Φ}_{{t}_{i}} ( x ) , {Φ}_{{t}_{j}} ( x ) / τ 〉 )}{{\sum }_{{t}_{k} ∈ T} exp ( 〈 {Φ}_{{t}_{i}} ( x ) , {Φ}_{{t}_{k}} ( x ) / τ 〉 )} , \qquad ( 4 )$$

where Φtᵢ(x) is a final projected feature representation of patch tᵢ, and τ is a temperature parameter.

Statement 13: The method of Statement 11 or 12, wherein:

$${f}_{loc} ( {t}_{i} , {t}_{j} ) = log ( ‖ {t}_{i} - {t}_{j} ‖ + 1 ) , \qquad ( 5 )$$

where tᵢ, tⱼ∈T, T is the set of all considered tokens, and ∥·∥ computes the spatial distance.

Statement 14: The method of any one of Statements 11 to 13, wherein:

$${λ}_{rep} ( {t}_{i} , {t}_{j} ) = \{ \begin{matrix}{Γ}_{att - att} & if {t}_{i} , {t}_{j} ∈ {T}_{att} \\ {Γ}_{inatt - inatt} & if {t}_{i} , {t}_{j} ∈ {T}_{inatt} \\ {Γ}_{att - inatt} , & otherwise\end{matrix} , \qquad ( 6 )$$

where Tₐₜₜ and T_{inatt′} denote attentive tokens and approximated inattentive tokens respectively; T=Tₐₜₜ∪T_{inatt′}, the set of all considered tokens; three types of correspondences are represented as: attentive-attentive (att-att), attentive-inattentive (att-inatt), and inattentive-inattentive (inatt-inatt), and each coefficient r is a hyperparameter.

Statement 15: A system comprising at least one processor, a non-transient storage device coupled to the at least one processor, the storage device storing instructions executable by the at least one processor to cause the system to: provide a network for facial landmark detection for faces in input images; and process, using the network, an input image comprising a face to determine and provide facial landmarks therefor; wherein the network comprises: encoder components configured for encoding features of the face, the encoder components comprising trained components of a Masked Image Modeling (MIM) network configured to processes non-overlapping patches determined from the input image, the MIM network trained with a SSL objective; and decoder components configured for determining local correspondences between the features for determining estimates for the facial landmarks, the decoder components trained to determine local correspondences comprising respective relationships between the features of the input image.

Statement 16: The system of Statement 15, wherein the MIM network comprises a MAE network.

Statement 17: The system of Statement 16, wherein the MAE network is configured as a vision transformer (ViT) using self-attention mechanisms to process images.

Statement 18: The system of any one of Statements 15 to 17 wherein the network comprises regressor components configured to determine the landmark estimations from features processed by the decoder components as trained, the regressor components configured in series with the decoder components as trained, and the decoder components in series with the encoder components as trained.

Statement 19: The system of any one of Statements 15 to 18, wherein the decoder components are trained as components of a projector network, the decoder components in series with the encoder components as trained.

Statement 20: The system of Statement 19, wherein the decoder components are trained using a locality constrained repellence (LCR) loss.

Statement 21: The system of Statement 20, wherein the LCR operates on features of landmark regions and combined information from non-landmark regions that reduces processing to achieve selective correspondence processing for the local correspondences.

Statement 22: The system of Statement 21, wherein LCR loss is defined in accordance with:

$${ℒ}_{LCR} = {\sum }_{{t}_{i} ∈ T} {\sum }_{{t}_{j} ∈ T} {f}_{loc} ( {t}_{i} , {t}_{j} ) \cdot {λ}_{rep} ( {t}_{i} , {t}_{j} ) \cdot p ( {t}_{i} \vert {t}_{j} ; Φ , x ) , \qquad ( 7 )$$

where: f_{loc}(tᵢ, tⱼ) defines a locality constraint; λᵣₑₚ(tᵢ, tⱼ) defines a repellence coefficient, prioritizing landmark differentiation and landmark vs non-landmark disambiguation over non-landmark differentiation respectively; and p(tᵢ|tⱼ; Φ, x) defines a correspondence as a probability that a patch token tⱼ corresponds to a patch token tᵢ in the image x.

Statement 23: The system of Statement 22, wherein:

$$p ( {t}_{i} \vert {t}_{j} ; Φ , x ) = \frac{exp ( 〈 {Φ}_{{t}_{i}} ( x ) , {Φ}_{{t}_{j}} ( x ) / τ 〉 )}{{\sum }_{{t}_{k} ∈ T} exp ( 〈 {Φ}_{{t}_{i}} ( x ) , {Φ}_{{t}_{k}} ( x ) / τ 〉 )} , \qquad ( 4 )$$

where Φₜ_{ᵢ}(x) is a final projected feature representation of patch tᵢ, and τ is a temperature parameter.

Statement 24: The system of any one of Statements 22 or 23, wherein:

$${f}_{loc} ( {t}_{i} , {t}_{j} ) = log ( ‖ {t}_{i} - {t}_{j} ‖ + 1 ) , \qquad ( 5 )$$

where tᵢ, tⱼ∈T, T is the set of all considered tokens, and ∥·∥ computes the spatial distance.

Statement 25: The system of any one of Statements 22 to 24, wherein:

$${λ}_{rep} ( {t}_{i} , {t}_{j} ) = \{ \begin{matrix}{Γ}_{att - att} & if {t}_{i} , {t}_{j} ∈ {T}_{att} \\ {Γ}_{inatt - inatt} & if {t}_{i} , {t}_{j} ∈ {T}_{inatt} \\ {Γ}_{att - inatt} , & otherwise\end{matrix} , \qquad ( 6 )$$

where Tₐₜₜ and T_{inatt′} denote attentive tokens and approximated inattentive tokens respectively; T=Tₐₜₜ∪T_{inatt′}, the set of all considered tokens; three types of correspondences are represented as: attentive-attentive (att-att), attentive-inattentive (att-inatt), and inattentive-inattentive (inatt-inatt), and each coefficient r is a hyperparameter.

Statement 26: The system of any one of Statements 15 to 25, wherein the instructions are executable to further cause the system to apply an effect to the input image using the facial landmarks.

Statement 27: The system of Statement 26, wherein the effect simulates a product or service applied to the face to provide a virtual try on experience.

Statement 28: The system of Statement 27, wherein the product comprises a makeup product or an appliance product; and the service comprises a cosmetic procedure or a surgical procedure or other face altering procedure.

Statement 29: The system of any one of Statements 15 to 28, wherein the network is a component of or communicates with an application and the facial landmarks are provided for further use by the application, wherein the application comprises any of a VTO application; a teleconsultation application, a video chat application, a video conference application, or a facial recognition application.

Practical implementation may include any or all of the features described herein. These and other aspects, features and various combinations may be expressed as methods, apparatus, systems, means for performing functions, program products, and in other ways, combining the features described herein. A number of embodiments have been described. Nevertheless, it will be understood that various modifications can be made without departing from the spirit and scope of the processes and techniques described herein. In addition, other steps can be provided, or steps can be eliminated, from the described process, and other components can be added to, or removed from, the described systems. Accordingly, other embodiments are within the scope of the following claims.

Throughout the description and claims of this specification, the word “comprise” and “contain” and variations of them mean “including but not limited to” and they are not intended to (and do not) exclude other components, integers or steps. Throughout this specification, the singular encompasses the plural unless the context requires otherwise. In particular, where the indefinite article is used, the specification is to be understood as contemplating plurality as well as singularity, unless the context requires otherwise. By way of example and without limitation, references to a computing device comprising a processor and/or a storage device includes a computing device having multiple processors and/or multiple storage devices. Herein, “A and/or B” means A or B or both A and B.

Features, integers characteristics, compounds, chemical moieties or groups described in conjunction with a particular aspect, embodiment or example of the invention are to be understood to be applicable to any other aspect, embodiment or example unless incompatible therewith. All of the features disclosed herein (including any accompanying claims, abstract and drawings), and/or all of the steps of any method or process so disclosed, may be combined in any combination, except combinations where at least some of such features and/or steps are mutually exclusive. The invention is not restricted to the details of any foregoing examples or embodiments. The invention extends to any novel one, or any novel combination, of the features disclosed in this specification (including any accompanying claims, abstract and drawings) or to any novel one, or any novel combination, of the steps of any method or process disclosed.

It will be understood that corresponding computer implemented method aspects and/or computer program product aspects are also disclosed. A computer program product, for example, comprises a storage device storing computer readable instructions that when executed by at least one processor of a computing device causes the computing device to perform operations of a computer implemented method.

What is claimed is:

1. A computer implemented method for self-supervised learning (SSL) training of a network for facial landmark detection for a face in an input image, wherein the network comprises encoder components encoding features of the face and decoder components determining local correspondences between the features for determining landmark estimates, the method comprising:
training a first network comprising a Masked Image Modeling (MIM) network that processes non-overlapping patches determined from the input image with a SSL objective, wherein the encoder components comprise a portion of the MIM network to encode features of the input image for decoding; and
training a second network comprising the encoder components, as trained, in series with the decoder components, the decoder components trained to determine local correspondences comprising respective relationships between the features of the input image provided by the encoder components.

2. The method of claim 1, wherein the MIM network comprises a MAE network.

3. The method of claim 2, wherein the MIM network, as trained, is configured to: provide respective tokens for the patches for processing by the decoder components; and combine information from tokens related to non-landmark regions of the input image to define approximated tokens, reducing the number of tokens for processing by the decoder components.

4. The method of claim 3, wherein the MIM network, as trained, is configured to:
define respective patch tokens for each patch and a class (CLS) token representing the image as an aggregation of information from the respective patch tokens;
identify each patch token as an attentive token or an inattentive token in accordance with a respective similarity to the CLS token determined for each patch token; and
combine information from inattentive tokens to provide approximated inattentive tokens, reducing the number of inattentive tokens for processing by the decoder components.

5. The method of claim 4, wherein the MIM network, as trained, is configured to perform inattentive token clustering to combine the information from the inattentive tokens, defining cluster centers to represent the information.

6. The method of claim 2, wherein the MAE network is configured as a vision transformer (ViT) using self-attention mechanisms to process images.

7. The method of claim 1 comprising training a final network for landmark detection, the final network comprising regressor components configured to determine the landmark estimations features processed by the decoder components as trained, the regressor components configured in series with the decoder components as trained, and the decoder components in series with the encoder components as trained.

8. The method of claim 1, wherein the second network comprises a projector network, the decoder components comprising a portion of the projector network.

9. The method of claim 8, wherein training the decoder components trains the projector network using a locality constrained repellence (LCR) loss.

10. The method of claim 9, wherein the LCR operates on features of landmark regions and combined information from non-landmark regions that reduces processing to achieve selective correspondence processing for the local correspondences.

11. The method of claim 10, wherein LCR loss is defined in accordance with:
$${ℒ}_{LCR} = {\sum }_{{t}_{i} ∈ T} {\sum }_{{t}_{j} ∈ T} {f}_{loc} ( {t}_{i} , {t}_{j} ) \cdot {λ}_{rep} ( {t}_{i} , {t}_{j} ) \cdot p ( {t}_{i} \vert {t}_{j} ; Φ , x ) , \qquad ( 7 )$$
where:
f_{loc}(tᵢ, tⱼ) defines a locality constraint;
λᵣₑₚ(tᵢ, tⱼ) defines a repellence coefficient, prioritizing landmark differentiation and landmark vs non-landmark disambiguation over non-landmark differentiation respectively; and
p(tᵢ|tⱼ; Φ, x) defines a correspondence as a probability that a patch token tⱼ corresponds to a patch token tᵢ in the image x.

12. A system comprising at least one processor, a non-transient storage device coupled to the at least one processor, the storage device storing instructions executable by the at least one processor to cause the system to:
provide a network for facial landmark detection for faces in input images; and
process, using the network, an input image comprising a face to determine and provide facial landmarks therefor;
wherein the network comprises:
encoder components configured for encoding features of the face, the encoder components comprising trained components of a Masked Image Modeling (MIM) network configured to processes non-overlapping patches determined from the input image, the MIM network trained with a SSL objective; and
decoder components configured for determining local correspondences between the features for determining estimates for the facial landmarks, the decoder components trained to determine local correspondences comprising respective relationships between the features of the input image.

13. The system of claim 12, wherein the MIM network comprises a MAE network.

14. The system of claim 13, wherein the MAE network is configured as a vision transformer (ViT) using self-attention mechanisms to process images.

15. The system of claim 12, wherein the network comprises regressor components configured to determine the landmark estimations from features processed by the decoder components as trained, the regressor components configured in series with the decoder components as trained, and the decoder components in series with the encoder components as trained.

16. The system of claim 12, wherein the decoder components are trained as components of a projector network, the decoder components in series with the encoder components as trained.

17. The system of claim 12, wherein the instructions are executable to further cause the system to apply an effect to the input image using the facial landmarks.

18. The system of claim 17, wherein the effect simulates a product or service applied to the face to provide a virtual try on experience.

19. The system of claim 18, wherein the product comprises a makeup product or an appliance product; and the service comprises a cosmetic procedure or a surgical procedure or other face altering procedure.

20. The system of claim 12, wherein the network is a component of or communicates with an application and the facial landmarks are provided for further use by the application, wherein the application comprises any of a VTO application; a teleconsultation application, a video chat application, a video conference application, or a facial recognition application.
